(19) United States
(12) Patent Application Publication
(10) Pub. No.: US 2009/0268582 A1
(43) Pub. Date: Oct. 29, 2009

(54) OPTICAL INFORMATION REPRODUCING APPARATUS AND METHOD THEREOF

(75) Inventors: Yuichiro Yamamoto, Kanagawa (JP); Shinichi Tatsuta, Tokyo (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/430,950

(22) Filed: Apr. 28, 2009

(30) Foreign Application Priority Data
Apr. 28, 2008 (JP) 2008-117379

(51) Int. Cl. G11B 7/135

(52) U.S. Cl. 369/112.03; 369/112.01; G9B/7.112

(57) ABSTRACT

An optical information reproducing apparatus includes a light-receiving unit that receives a first reproduction light of an information output from a first region of an information recording layer and a second reproduction light of an information output from a second region of the information recording layer, the first region and the second region being formed by dividing the information recording layer with a line segment that intersects a plane of incidence of the reference light and a plane of the information recording layer, and outputs a first reproduction signal that is a reproduction signal of the first region and a second reproduction signal that is a reproduction signal of the second region.

### CROSS-REFERENCE TO RELATED APPLICATIONS

This application is based upon and claims the benefit of priority from the prior Japanese Patent Application No. 2008-117379, filed on Apr. 28, 2008; the entire contents of which are incorporated herein by reference.

### BACKGROUND OF THE INVENTION

1. Field of the Invention

The present invention relates to an optical information reproducing apparatus and an optical information reproducing method.

2. Description of the Related Art

After the emergence of compact discs (CDs), the capacity of optical discs has increased by reducing the wavelength of laser and by increasing the numerical aperture of objective lenses. However, with high definition digital versatile disc (HD DVD) and Blu-ray disc (BD) that use blue-violet semiconductor laser with a wavelength of a 405 nanometer (nm) band, it is said that the system is nearing the limit of its principle. To further increasing capacity, it is critical to establish an innovative recording and reproducing system. Under such a circumstance, a hologram recording/reproducing system that includes a high density optical recording medium (hereinafter, “holographic memory recording medium”) of a volume recording type using a hologram, and a holographic memory recording/reproducing device have received attention in recent years, and research and development aiming at the practical use has been promoted under industry-academia collaboration.

The recording principles of a hologram recording/reproducing system are to allow information light and reference light interfere with each other in a holographic memory recording medium, and to record information three-dimensionally as a fine interference fringe. A plurality of pieces of information can be multiplex-recorded on the same location in an information recording layer of the holographic memory recording medium. Accordingly, it is possible to realize a significantly large increase in capacity compared with a two-dimensional recording that records information on a flat surface using pits and marks, such as the HD DVD and the BD.

Various systems have been proposed to be used as a multiplexing system of the hologram recording/reproducing. A two-axis angular multiplexing system is one of the systems to increase recording density. The two-axis angular multiplexing system works as follows: Consider an xyz orthogonal coordinate fixed to a holographic memory recording medium, and take a z-axis in the thickness direction of the holographic memory recording medium, and take an x-axis and a y-axis perpendicular to each other in the direction perpendicular thereto, in other words, in the surface direction of the holographic memory recording medium. At this time, a plane of incidence of reference light and information light is an x-z plane.

The two-axis angular multiplexing system is a system that emits reference light and information light onto the holographic memory recording medium, and carries out angular multiplex recording while rotating the holographic memory recording medium about the y-axis, and carries out the angular multiplex recording while rotating the holographic memory recording medium about the z-axis. An angular multiplex recording performed by rotating the holographic memory recording medium about the y-axis is called a θ_{y} angular multiplex recording, and an angular multiplex recording performed by rotating the holographic memory recording medium about the z-axis is called a θ_{z} angular multiplex recording. Such a θ_{z} angular multiplex recording, for example, is disclosed in U.S. Pat. No. 5,483,365 or in JP-A 2000-338846 (KOKAI). In the U.S. Pat. No. 5,483,365, the θ_{z} angular multiplex recording is referred to as “peristrophic multiplexing”.

With the angular multiplexing of the holographic recording, the θ_{y} angular multiplex recording is generally used. Because the θ_{z} angular multiplex recording is also carried out in addition to the θ_{y} angular multiplex recording, and data is multiplex-recorded on the same location in an information recording layer of the holographic memory recording medium, the system is effective in increasing density.

A specific recording method and a reproduction method of the two-axis angular multiplexing system are as follows: While information is being recorded, laser light is emitted to a spatial light modulator such as a liquid crystal and a digital micromirror device (DMD), thereby generating information light including data. The data (hereinafter “page”) is a unit that records a hologram in which a two-dimensional modulation pattern that is an intensity modulation pattern made of bright spots and dark spots is encoded.

The information light is then collected on an information recording layer of a holographic memory recording medium by an objective lens. Reference light is led to the information recording layer of the holographic memory recording medium, through a different optical path from that of the information light. By allowing the reference light and the information light to interfere with each other, a page is recorded on the information recording layer as an interference fringe. By using an actuator, the holographic memory recording medium is rotated about a y-axis (hereinafter, “rotation θ_{y}”), or rotated about a z-axis (hereinafter, “rotation θ_{z}”), and the other pages are multiplex-recorded on the same location in the information recording layer.

To reproduce data, only reference light is emitted onto the information recording layer, and a page recorded on the information recording layer is reproduced, by rotating the holographic memory recording medium by θ_{y} or by θ_{z}. The reproduction light is converted into approximately parallel light by the objective lens, and received as a two-dimensional image by an optical detector of a two-dimensional image pickup device such as a complementary metal-oxide semiconductor (CMOS) or a charge-coupled device (CCD). Accordingly, the data can be obtained by decoding the page.

In a recording/reproducing device of a holographic memory recording medium that performs recording and reproducing of information using such a two-axis angular multiplexing system, it is necessary to perform a precise positioning servo by rotating and driving the holographic memory recording medium using the actuator. The positioning servo is carried out based on a servo signal used to carry out a positioning servo of the rotation θ_{y}, and a servo signal used to carry out a positioning servo of the rotation θ_{z}.

The simplest way to realize the positioning servo of the rotation θ_{z} is to embed a servo optical system that uses an angle sensor separately from the recording/reproducing optical system. However, due to the change in the usage environment, such as temperature and humidity, the hologram recorded on the information recording layer may be deformed or altered. Accordingly, a situation where the optimum position for reproducing information is different from that when the information was recorded, need to be considered. In this case, when the positioning servo is carried out by the angle sensor, fluctuations may occur. Accordingly, highly accurate recording and reproduction of information cannot be realized.

### SUMMARY OF THE INVENTION

According to one aspect of the present invention, an optical information reproducing apparatus comprising:

a light-receiving unit that receives a first reproduction light of an information output from a first region of an information recording layer and a second reproduction light of an information output from a second region of the information recording layer, the first region and the second region being formed by dividing the information recording layer with a line segment that intersects a plane of incidence of the reference light and a plane of the information recording layer, and outputs a first reproduction signal that is a reproduction signal of the first region and a second reproduction signal that is a reproduction signal of the second region; a driving unit that rotates the optical information recording medium in a thickness direction of the optical information recording medium and in a surface direction of the optical information recording medium; a differentiator that generates a servo signal by performing a differential operation on the first reproduction signal and on the second reproduction signal; and a record controlling unit that controls the light source to emit the illumination light, and performs angular multiplex recording of the information on the information recording layer, controlling rotation by the driving unit, adjusting a rotation angle in the thickness direction based on the servo signal.

According to another aspect of the present invention, An optical information reproducing method comprising:

receiving a first reproduction light of an information output from a first region of an information recording layer and a first reproduction light of an information output from a second region of the information recording layer, the first region and the second region being formed by dividing the information recording layer with a line segment that intersects a plane of incidence of the reference light and a plane of the information recording layer, and outputting a first reproduction signal that is a reproduction signal of the first region and a second reproduction signal that is a reproduction signal of the second region; rotating the optical information recording medium by a driving unit in a thickness direction of the optical information recording medium and in a surface direction of the optical information recording medium; generating a servo signal by performing a differential operation on the first reproduction signal and on the second reproduction signal; and controlling the light source to emit the illumination light, and performing angular multiplex recording of the information on the information recording layer, controlling rotation by the driving unit, adjusting a rotation angle in the thickness direction based on the servo signal.

### BRIEF DESCRIPTION OF THE DRAWINGS

FIG. 1 is a schematic view of a configuration of an optical system of a holographic memory recording/reproducing apparatus according to a first embodiment of the present invention, and a state of light beams while information is being recorded;

FIG. 2 is a schematic view of a configuration of the optical system of the holographic memory recording/reproducing apparatus according to the first embodiment, and a state of light beams while information is being reproduced;

FIG. 3 is a schematic view for explaining an arrangement and configuration of a DMD pattern;

FIG. 4 is a schematic view of an outline of a two-axis angular multiplexing system;

FIG. 5 is a schematic view for explaining the two-axis angular multiplexing system while information is being recorded;

FIG. 6 is a schematic view for explaining the two-axis angular multiplexing system while information is being reproduced;

FIG. 7A is a schematic view of the intensity distribution of reproduction signals at an optimum reproducing position;

FIG. 7B is a schematic view of the intensity distribution of reproduction signals, when a holographic memory recording medium 111 is rotated by θ_{z} only at a fine angle −δ deg from the optimum reproducing position;

FIG. 7C is a schematic view of the intensity distribution of reproduction signals, when the holographic memory recording medium 111 is rotated by θ_{z} only at a fine angle +δ deg from the optimum reproducing position;

FIG. 8 is a schematic view of an optical arrangement of optical components and a holographic memory recording medium while information is being recorded;

FIG. 9A is a schematic view of an optical arrangement of the holographic memory recording medium while information is being reproduced;

FIG. 9B is another schematic view of the optical arrangement of the holographic memory recording medium while information is being reproduced;

FIG. 10A is still another schematic view of the optical arrangement of the holographic memory recording medium while information is being reproduced;

FIG. 10B is still another schematic view of the optical arrangement of the holographic memory recording medium while information is being reproduced;

FIG. 11 is a schematic view of regions A, B, and C in a reproduction image;

FIG. 12A is a graph of the reproduction intensity for rotation θ_{z} in the region A of the reproduction image;

FIG. 12B is a graph of the reproduction intensity for rotation θ_{z} in the region B of the reproduction image;

FIG. 12C is a graph of the reproduction intensity for rotation θ_{z} in the region C of the reproduction image;

FIG. 13 is a schematic view of a generation method of a servo signal;

FIG. 14 is a graph of a waveform of a servo signal generated by a differentiator, used for performing positioning control of the rotation θ_{z};

FIG. 15 is a flowchart of a processing procedure of the positioning control of the rotation θ_{z} of the holographic memory recording medium according to the embodiment;

FIG. 16 is a schematic view of a configuration of an optical system of a holographic memory recording/reproducing apparatus according to a second embodiment of the present invention;

FIG. 17A is a schematic view of the intensity distribution of reproduction signals at an optimum reproducing position;

FIG. 17B is a schematic view of the intensity distribution of reproduction signals, when a holographic memory recording medium is rotated by θ_{z} only at a fine angle −δ deg from the optimum reproducing position;

FIG. 17C is a schematic view of the intensity distribution of reproduction signals, when the holographic memory recording medium is rotated by θ_{z} only at a fine angle +δ deg from the optimum reproducing position;

FIG. 18 is a schematic view of a configuration of an optical system of a holographic memory recording/reproducing apparatus according to a third embodiment of the present invention;

FIG. 19 is a perspective view of an optical configuration at the side of an optical path of reproduction light output from a holographic memory recording medium; and

FIG. 20 is a schematic view of a configuration of an optical system of a holographic memory recording/reproducing apparatus according to a fourth embodiment of the present invention.

### DETAILED DESCRIPTION OF THE INVENTION

Exemplary embodiments of an optical information recording/reproducing apparatus and an optical information recording/reproducing method according to the present invention are described below in greater detail with reference to the accompanying drawings.

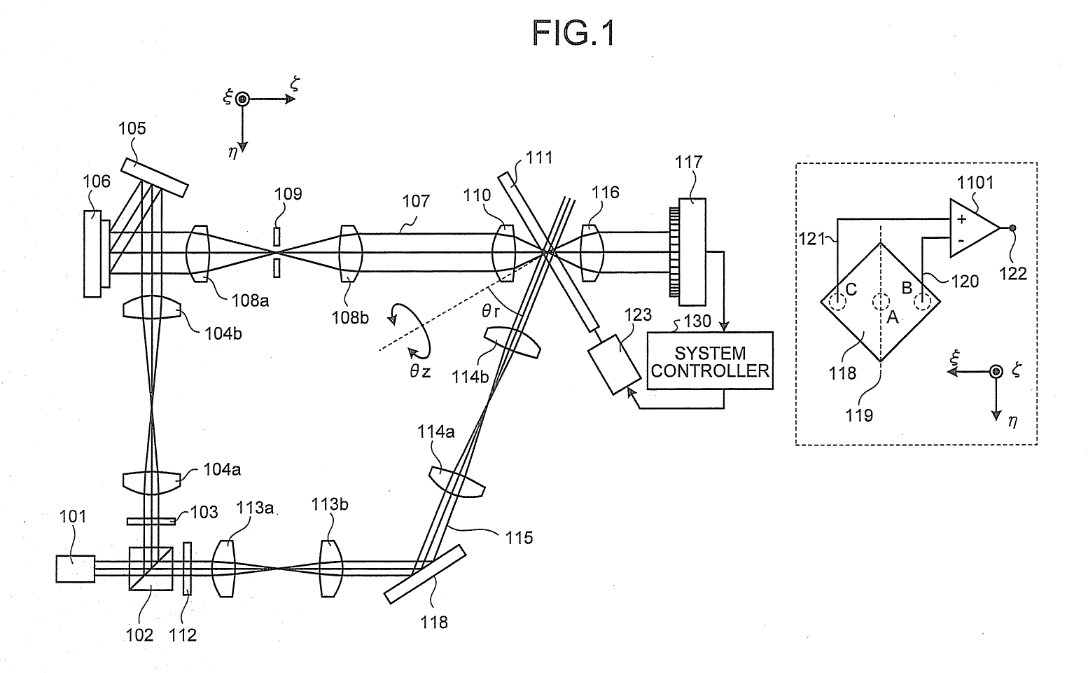

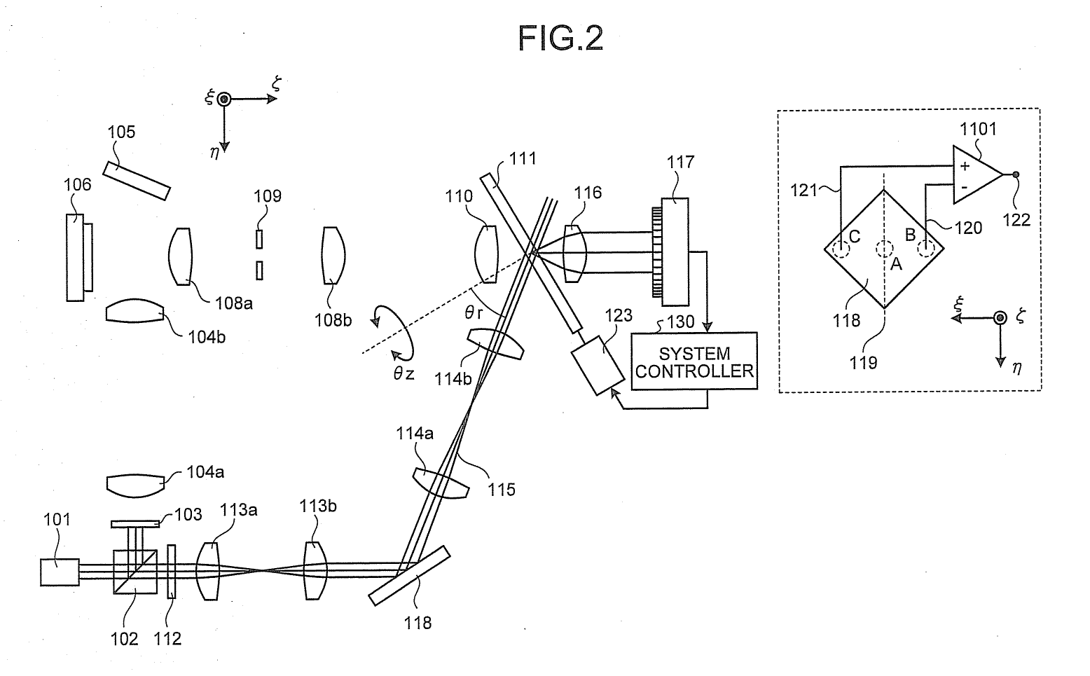

FIG. 1 will now be explained. FIG. 1 depicts a state of light beams while information is being recorded, and FIG. 2 depicts a state of light beams while information is being reproduced. The present embodiment employs a two-beam optical system that is a system in which information light and reference light are led into a holographic memory recording medium 111, so as to overlap in the holographic memory recording medium 111, through separate lenses and the like. However, the optical system is not limited to the two-beam system. A coaxial system (collinear system) that leads information light and reference light into the holographic memory recording medium 111, so as to share the same center axis, through the same objective lens and the like from the same direction, may be employed as the optical system.

A semiconductor laser device 101 is a laser light source that emits laser light. The laser light output from the semiconductor laser device 101 enters into a polarizing beam splitter 102. The semiconductor laser device 101 preferably emits blue-violet laser of a 405 nanometer band, from the viewpoint of design flexibility of a recording medium.

The wavefront of the laser light led into the polarizing beam splitter 102 will be divided. Among the rays of laser light, rays of laser light reflected by the polarizing beam splitter 102 are led to a mirror 105 by relay lenses 104a and 104b, after converted into S-polarized light, and led into a spatial light modulator 106 after being reflected by the mirror 105. A shutter 103 is opened during recording.

The intensity of the laser light led into the spatial light modulator 106 is two-dimensionally modulated by the spatial light modulator 106, and converted into information light 107. In the present embodiment, a digital micromirror device (DMD) made by Texas Instruments Incorporated is used for the spatial light modulator 106.

A DMD pattern of the spatial light modulator 106 is formed by a number of bright spots and dark spots, and is a two-valued pattern in which information to be recorded is digitally coded and an error correction is included. The DMD needs to be arranged so that a rotation axis of a finely movable mirror of the DMD formed on a silicon chip is in the diagonal direction from the pixel.

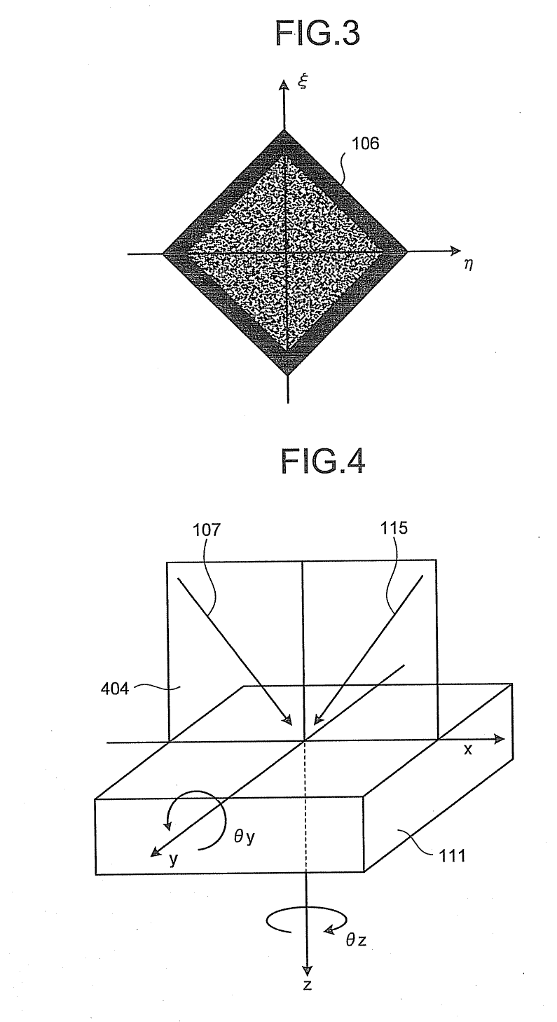

As shown in FIG. 1, in a ξηζ orthogonal coordinate system, the rotation axis of the finely movable mirror needs to be set in the ξ-axis direction. Accordingly, as shown in FIG. 3, the DMD is arranged so that the DMD pattern is inclined at 45 degrees.

Referring back to FIG. 1, the information light 107 whose intensity is modulated by the spatial light modulator 106, passes though relay lenses 108a and 108b. After unnecessary diffraction light is removed by an iris diaphragm 109, the information light 107 is collected, converged, and emitted onto an information recording layer of the holographic memory recording medium 111 by an objective lens 110. The holographic memory recording medium 111 is fixed to a stage (not shown) driven by a stepping motor 123 that is a driving unit.

Among the rays of laser light led into the polarizing beam splitter 102, rays of laser light that transmitted through the polarizing beam splitter 102 are converted into P-polarized light, and used as reference light 115. The reference light 115 is converted into S-polarized light, the same as that of the information light 107 led into the holographic memory recording medium 111, by a half-wave plate 112. The reference light 115 transmits through relay lenses 113a and 113b, a mirror 118, relay lenses 114a and 114b, and emits the holographic memory recording medium 111 as parallel light beams, by having the beam diameter reduced. Accordingly, information is recorded, because the reference light 115 interferes with the information light 107 in the information recording layer of the holographic memory recording medium 111.

The holographic memory recording medium 111 according to the embodiment is a transmission type recording medium, and includes two opposing substrates and a hologram recording layer sandwiched between the two substrates.

The substrate is formed of a material having optical transparency such as glass, polycarbonate, and acrylic resin. However, the material of the substrate is not limited to these. For example, the material need not be transparent to all wavelengths of laser light, but may be transparent only to the wavelength of laser light to be used.

The information recording layer is formed of a hologram recording material. The hologram recording material is a material on which a hologram is formed, by allowing information light and reference light of laser light to interfere with each other. A typical hologram recording material is a photopolymer. The photopolymer is a photosensitive material that uses photopolymerization of the polymerizable compound (monomer). Generally, the photopolymer includes a monomer as a main component, a photopolymerization initiator, and a matrix having porous structure that maintains the volume before and after the recording. The thickness of the recording material is preferably about equal to or more than 100 micrometers, to achieve sufficient diffraction efficiency for reproducing signals and sufficient angle resolution during angular multiplexing. Other materials such as dichromate gelatin and a photorefractive crystal may also be used as the hologram recording material.

With such an optical system, the hologram recording to the hologram recording layer of the holographic memory recording medium 111 is performed as follows: An interference fringe is formed by overlapping information light and reference light in the hologram recording layer. At this time, the photopolymerization initiator in the photopolymer absorbs photons and is activated, and invokes and stimulates the polymerization of the monomer in a bright unit of the interference fringe. When monomer in the bright unit of the interference fringe is consumed with the progress of the polymerization of the monomer, monomer is moved and supplied to the bright unit from a dark unit of the interference fringe. As a result, a density difference occurs between the bright unit and the dark unit of the interference fringe pattern. Accordingly, refractive-index modulation based on the intensity distribution of the interference fringe pattern is formed, thereby performing hologram recording.

As the hologram recording system according to the present embodiment, a two-axis angular multiplexing system is employed. In the two-axis angular multiplexing system, a system controller 130 instructs the stepping motor 123 to rotate the holographic memory recording medium 111 in the thickness direction of the medium (rotation θ_{z}) and rotate the holographic memory recording medium 111 in the surface direction of the medium (rotation θ_{y}). Accordingly, the angle of incidence to the holographic memory recording medium 111 is changed, and other pages are sequentially multiplex-recorded on the same location in the information recording layer of the holographic memory recording medium 111.

As shown in FIG. 4, consider an xyz orthogonal coordinate system fixed to the holographic memory recording medium 111, and take a z-axis in the thickness direction of the holographic memory recording medium 111, and take an x-axis and a y-axis perpendicular thereto, in the surface direction of the medium. In FIG. 4, a plane of incidence 404 of the reference light 115 and the information light 107 is an xz plane.

In the two-axis angular multiplexing system, as shown in FIG. 4, the angular multiplex recording is performed by emitting the reference light 115 and the information light 107 onto the holographic memory recording medium 111, and rotating the holographic memory recording medium 111 about the y-axis. The angular multiplex recording is also performed while the holographic memory recording medium 111 is rotated about the z-axis.

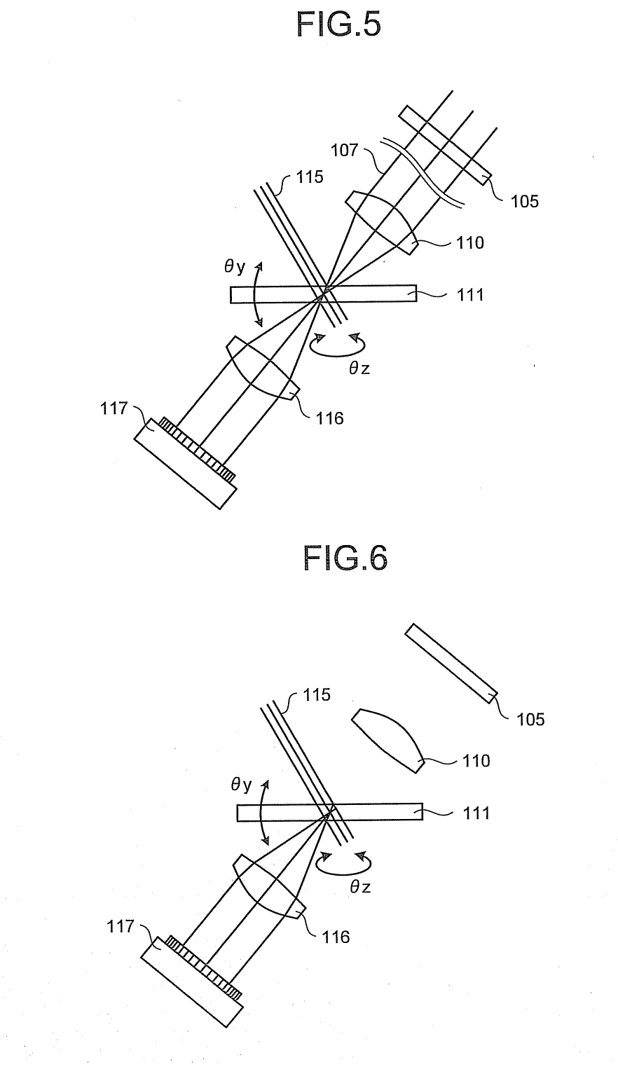

More specifically, as shown in FIG. 5, the information light 107 is collected on the information recording layer of the holographic memory recording medium 111 by the objective lens 110, and a page is recorded by allowing the information light 107 and the reference light 115 interfere with each other as an interference fringe. The system controller 130 then controls the drive of the stepping motor 123, and rotates the holographic memory recording medium 111 about the y-axis (rotation θ_{y}), or rotates the holographic memory recording medium 111 about the z-axis (rotation θ_{z}). Accordingly, the other pages are multiplex-recorded on the same location in the information recording layer of the holographic memory recording medium 111.

To reproduce the information, as shown in FIG. 2, the information light 107 is blocked by closing the shutter 103, and as shown in FIG. 6, only the reference light 115 is emitted onto the holographic memory recording medium 111. By rotating the holographic memory recording medium 111 by θ_{y} or by θ_{z}, the page recorded on the information recording layer is reproduced. More specifically, the reference light 115 emitted onto the holographic memory recording medium 111 is diffracted and transmitted by the holographic memory recording medium 111, and emitted as reproduction light. The reproduction light is converted into approximately parallel light beams by an objective lens 116. A two-dimensional image pickup device 117 formed by a CMOS or a CCD receives the reproduction light as a two-dimensional image. Data is obtained by decoding the page from a reproduction signal of which the reproduction light is converted into an electric signal.

The system controller 130, as described above, functions as a record controlling unit that controls two-axis multiplex recording, by controlling the drive of the stepping motor 123, and by rotating the holographic memory recording medium 111 by θ_{y} or by θ_{z}. The system controller 130 obtains a reproduction signal from the two-dimensional image pickup device 117. By including a differentiator (will be described later) that produces a servo signal, which will be described later, from the reproduction signal, the system controller 130 controls the positioning of the rotation θ_{z} of the holographic memory recording medium 111, based on the servo signal.

As will hereinafter be described in detail, in the present embodiment, in the reproduction image of the reproduction light received by the two-dimensional image pickup device 117, a differentiator 1101 in the system controller 130 performs a differential operation on a reproduction signal 120 from a peripheral region B and on a reproduction signal 121 from a peripheral region C. A differential signal output from an output terminal 122 of the differentiator 1101 is used as a servo signal.

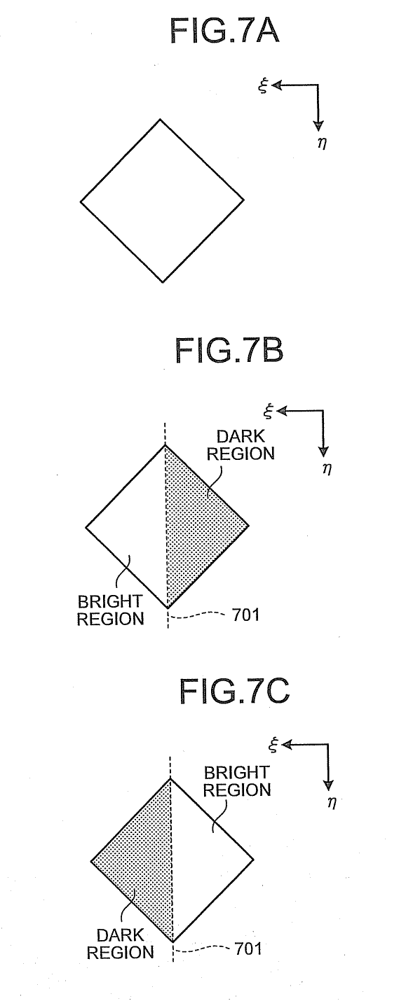

The positioning control of the rotation θ_{z} of the holographic memory recording medium 111 will now be described. FIGS. 7A to 7C are schematic views of the intensity distributions of reproduction signals, when the holographic memory recording medium 111 is rotated by θ_{z} only at a fine angle from an optimum reproducing position. In FIGS. 7A to 7C, a ξη-axis corresponds to the ξη-axis shown in FIG. 1. The reproduction image corresponds to the DMD pattern (input image) shown in FIG. 3, and is inclined at 45 degrees.

FIG. 7A is a schematic view of the intensity distribution of reproduction signals at the optimum reproducing position. To be precise, the reproduction image is a two-dimensional pattern formed by a number of bright spots and dark spots. For explanation purposes, the whole of FIG. 7A is illustrated by bright spots. FIG. 7B is a schematic view of the intensity distribution of reproduction signals, when the holographic memory recording medium 111 is rotated by θ_{z} only at a fine angle −δ deg from the optimum reproducing position (FIG. 7A). FIG. 7C is a schematic view of the intensity distribution of reproduction signals, when the holographic memory recording medium 111 is rotated by θ_{z} only at a fine angle +δ deg from the optimum reproducing position (FIG. 7A).

A dotted line 701 in FIGS. 7B and 7C is a line segment where a plane of incidence of the reference light 115 intersects with the reproduction image (a plane of the holographic memory recording medium 111). When the holographic memory recording medium 111 is rotated by θ_{z} only at a fine angle, as shown in FIGS. 7B and 7C, there is a characteristic that the two regions at the left and the right separated by the line segment (dotted lines) 701 are divided into a bright region and a dark region, thereby generating intensity fluctuations. As shown in FIGS. 7B and 7C, if the rotating direction of θ_{z} at a fine angle is reversed, the characteristic of the intensity fluctuations is also reversed. Accordingly, the bright region in FIG. 7B becomes a dark region in FIG. 7C, and the dark region in FIG. 7B becomes a bright region in FIG. 7C. The intensity fluctuations in the reproduction image due to the rotation θ_{z} of the holographic memory recording medium 111 do not occur significantly with the rotation θ_{y}. Accordingly, this is a characteristic specific to the rotation θ_{z}.

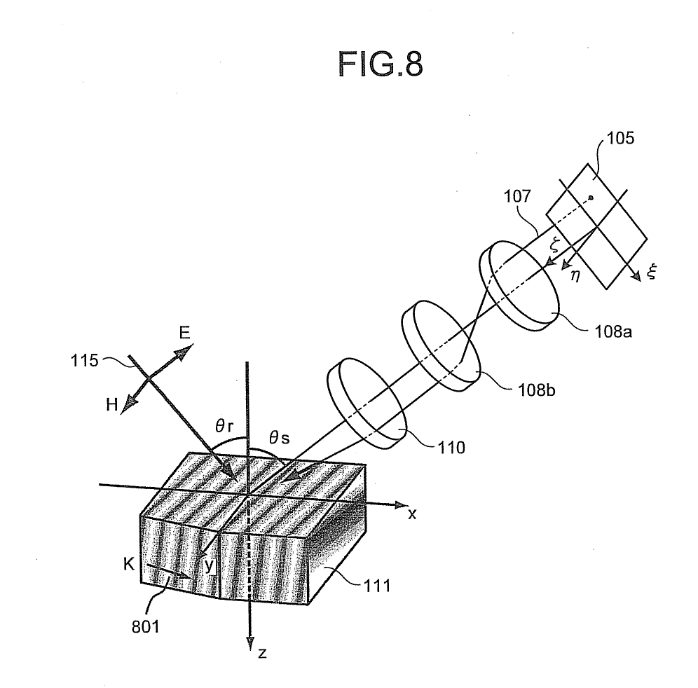

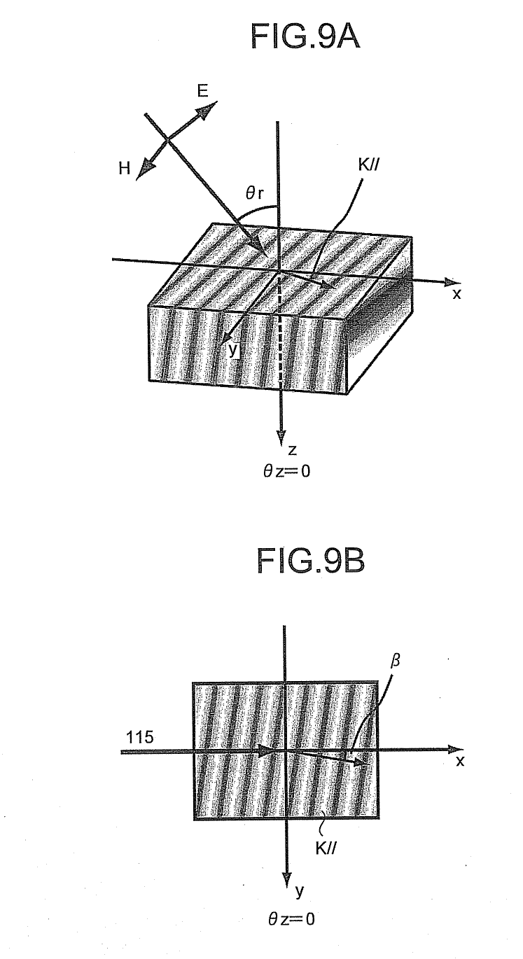

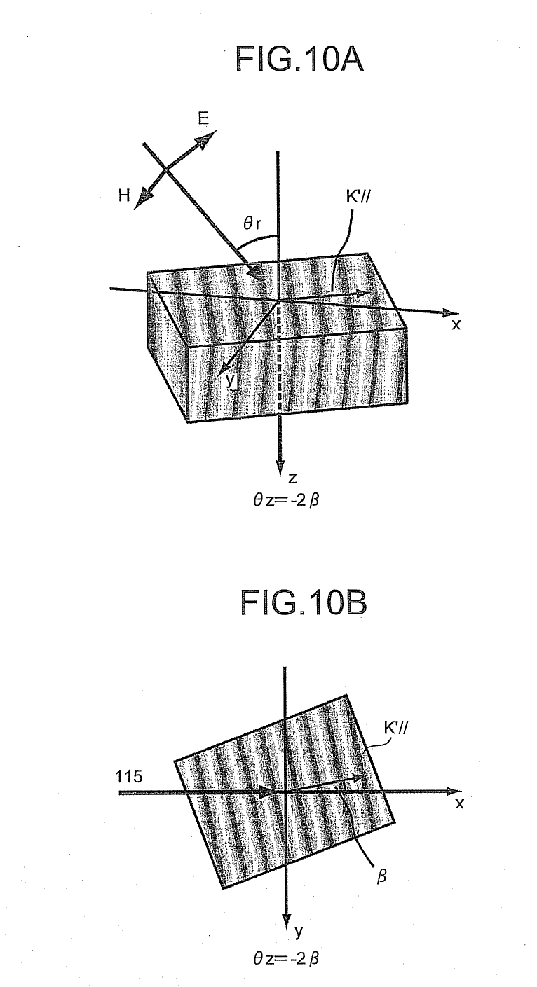

The physical reason why the intensity fluctuations occur in the reproduction image with the rotation θ_{z} of the holographic memory recording medium 111 will now be described. FIG. 8 is a schematic view of an optical arrangement of optical components and the holographic memory recording medium 111 while information is being recorded. FIGS. 9A, 9B, 10A, and 10B are schematic views of an optical arrangement of the holographic memory recording medium 111 while information is being reproduced.

The reference light 115 is parallel light beams, and the information light 107 is condensed light beams collected on the holographic memory recording medium 111 by the objective lens 110. As shown in FIGS. 8, 9A, 9B, 10A, and 10B, when information is being recorded, a plane of incidence including optical axes of the reference light 115 and the information light 107 is an xz plane, and assume that the coordinates are fixed.

A diffraction grating recorded by the reference light 115 and the information light 107 from a region outside the axis not present on the plane of incidence of the input image is an oblique lattice. In the diffraction grating, as shown in FIG. 8, K_{y} that is a y component of a lattice vector K=(Kₓ, K_{y}, K_{z}) is non-zero oblique lattice. When an angle between a vector K// that projected the lattice vector K on an xy plane and the x-axis is an angle β, the following formula (1) is established:

β=tan⁻¹(K_{y}/Kₓ) (1)

where, β is an angle between a vector K// that projected a lattice vector K on an xy surface and an x-axis.

The reproduction condition is considered in k-space. As shown in FIGS. 9A and 9B, when the reference light 115 is emitted to the oblique lattice at θ_{z}=0 deg, while information is being reproduced, because the optical arrangement of the optical components and the holographic memory recording medium 111 are the same as that while information is being recorded, the Bragg condition is satisfied, thereby generating reproduction light. At this time, the size of the wave vector k_{sig} (θ_{z}=0) of the reproduction light in the holographic memory recording medium 111 is given by the following formulae (2-1) and (2-2).

|k_{sig}(θ_{z}=0)|=\sqrt{(k_{refx}−Kₓ)²+(0−K_{y})²+(k_{refz}−K_{z})²} (2-1)

k_{sig}=k_{ref}−K (2-2)

As shown in FIGS. 10A and 10B, assume when the reference light 115 is emitted, by rotating the holographic memory recording medium 111 by θ_{z}=−2β deg, while information is being reproduced. In this case, the lattice vector is K′=(Kₓ, −K_{y}, K_{z}). Accordingly, the size of the wave vector k_{sig} (θ_{z}=−2β) of the reproduction light is given by the following formulae (3-1) and (3-2).

|k_{sig}(θ_{z}=−2β)|={square root over ((k_{refx}−Kₓ)²+(0−(−K_{y})²+(k_{refz}−K_{z})²)} (3-1)

k_{sig}=k_{ref}−K′ (3-2)

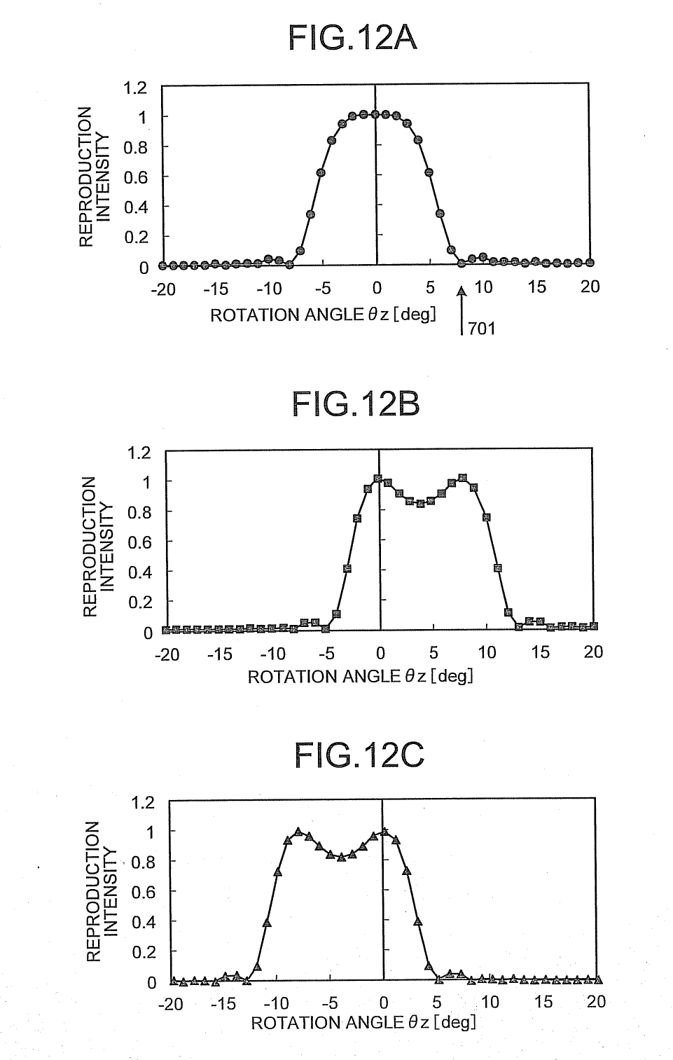

Because the formula (2-1) and the formula (3-1) are the same value, the Bragg condition is satisfied. Accordingly, strong reproduction light is generated. Subsequently, the reproduction intensity is biased towards the positive direction and the negative direction of the rotation θ_{z}, thereby creating a waveform with two peaks. As a result, intensity fluctuations are generated in the reproduction image (see FIGS. 12B and 12C, which will be described later).

In the present embodiment, by using the intensity fluctuations in the reproduction image, a servo signal used to control the positioning of the rotation θ_{z} of the holographic memory recording medium 111 is produced. The production of the servo signal will be described in detail below.

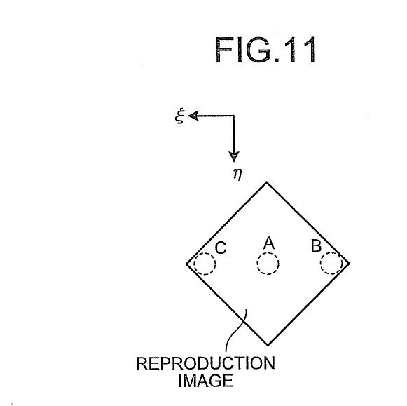

FIG. 11 is a schematic view of regions A, B, and C in a reproduction image. The region A is the center region of the reproduction image, and is the region positioned on the line segment where the plane of incidence of the reference light 115 intersects with the reproduction image (a plane of the holographic memory recording medium 111). The regions B and C are peripheral regions of the reproduction image. In FIG. 11, the distance between the region A and the region B, and the distance between the region A and the region C are equal.

FIGS. 12A to 12C are graphs of the reproduction intensity in the reproduction image, for the rotation θ_{z} in the regions A, B, and C in FIG. 11. FIG. 12A is the intensity (reproduction intensity) of the reproduction signal for the rotation angle θ_{z} in the region A of the reproduction image. FIG. 12B is the reproduction intensity for the rotation θ_{z} in the region B of the reproduction image. FIG. 12C is the reproduction intensity for the rotation θ_{z} in the region C of the reproduction image. In FIGS. 12A to 12C, the horizontal axis indicates the rotation angle θ_{z}, and the vertical axis indicates the reproduction intensity (relative value) that is the intensity of the reproduction signal generated by the reproduction light received by the two-dimensional image pickup device 117.

FIGS. 12A to 12C depict characteristics that have been proven both by theory and experiments, and in the present diagrams, the calculation results obtained by electromagnetic field analysis are shown. In the optical configuration show in FIG. 1, optical parameters are as follows: angle of incidence θᵣ of the reference light 115 is 22.5 degrees, angle of incidence θₛ of the information light 107 is 22.5 degrees, pixel length at the spatial light modulator 106 is 15 micrometers, image size is 200×200 pixels, thickness of the holographic memory recording medium 111 is 200 micrometers, and focal lengths of the lenses 108a and 108b, and the objective lens 110 are 100 millimeters, 150 millimeters, and 30 millimeters, respectively.

An output waveform of the reproduction intensity in the center region A of the reproduction image, as shown in FIG. 12A, is symmetrical to the positive and negative rotations of the rotation θ_{z}. This is a well-known optical characteristic, and the angle at which the output signal is the first null, for example, is shown by the following formula (4). The formula (4) is a calculation formula given in “Method for holographic storage using peristrophic multiplexing”, Optics Letters, Vol. 19, No. 13 (1994).

$$d θ = {\{ \frac{2 λ}{t} [ \frac{cos {θ}_{s}}{sin {θ}_{r} ( sin {θ}_{s} + sin {θ}_{r} )} ] \}}^{1 / 2} \qquad ( 4 )$$

The reproduction intensities in the peripheral regions B and C of the reproduction image, as shown in FIGS. 12B and 12C, are asymmetrical waveforms. In other words, in the peripheral region B of the reproduction image, the rotation angle θ_{z} of the first null is approximately −5 deg and approximately 13 deg, and the reproduction image tends to disappear at the rotation θ_{z} in the negative direction. In the peripheral region C of the reproduction image, the rotation angle θ_{z} of the first null is approximately −13 deg and approximately 5 deg, and the reproduction image tends to disappear at the rotation θ_{z} in the positive direction. The characteristics are not mentioned in the above literature, and are unknown characteristics. The inventor of the present invention has discovered the characteristics that the reproduction intensity differs depending on the regions in the reproduction image. By using the characteristics, and by using the system controller 130, a servo signal for the rotation fluctuations caused by the rotation θ_{z} of the holographic memory recording medium 111 is generated, thereby controlling the positioning of the rotation θ_{z}. In other words, the system controller 130 performs a differential operation on the reproduction signal in the peripheral region B of the reproduction image shown in FIG. 12B, and on the reproduction signal in the peripheral region C of the reproduction image shown in FIG. 12C, thereby generating a servo signal for controlling the positioning of the rotation θ_{z}.

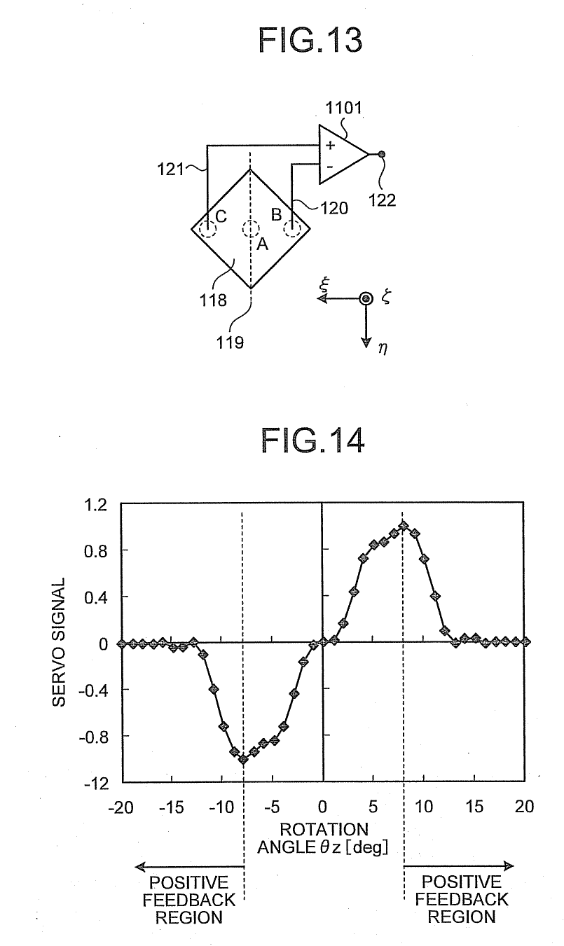

As shown in FIG. 13, in a reproduction image 1318 of the reproduction light received by the two-dimensional image pickup device 117, the differentiator 1101 that functions as a generating unit in the system controller 130 performs a differential operation on the reproduction signal 120 from the peripheral region B shown in FIG. 12B and on the reproduction signal 121 from the peripheral region C shown in FIG. 12C. A differential signal output from the output terminal 122 of the differentiator 1101 is used as a servo signal.

In other words, if the reproduction signal 120 from the region B is indicated by SB, and if the reproduction signal 121 from the region C is indicated by SC, a servo signal Sr used to control the positioning of the rotation θ_{z} is generated by the differentiator 1101 by the following formula (5):

Sr=SB−SC (5)

As described above, because the reproduction image is formed by the bright spots and the dark spots, the region B and the region C preferably include a sufficient number of bright spots and dark spots, so that if the data modulation systems are the same, the value of the reproduction signal does not fluctuate much even if the input image is changed.

As shown in FIG. 14, in a region other than a positive feedback region, a so-called S-curve in which the servo signal becomes a positive value for the rotation θ_{z} in the positive direction, and becomes a negative value for the rotation θ_{z} in the negative direction can be obtained. Accordingly, in a region other than the positive feedback region, the servo signal can be used as a servo signal for the rotation θ_{z} of the holographic memory recording medium 111. In the present embodiment, the system controller 130 drives the stepping motor 123 and coarsely adjusts the positioning of the rotation θ_{z} of the holographic memory recording medium 111. The system controller 130 then performs a differential operation on the reproduction signal SB from the region B and on the reproduction signal SC from the region C by the formula (5), and calculates the servo signal Sr using optical characteristics. The system controller 130 controls the positioning of the rotation θ_{z} by using the servo signal Sr.

In the positive feedback region shown in FIG. 14, the servo signal does not take the positive or the negative value by corresponding to the rotation θ_{z} in the positive and the negative directions. Accordingly, the precise positioning control of the rotation θ_{z} cannot be performed. Subsequently, the system controller 130 of the present embodiment uses the reproduction signal in the center region A of the reproduction image to determine a threshold value for turning the servo on and off, to prevent the positioning control of the rotation θ_{z} from being performed in the positive feedback region.

In other words, if a reproduction signal from the center region A of the reproduction image is SA, the system controller 130, when the reproduction signal SA is equal to or more than a predetermined threshold value, determines that the region is a region other than the positive feedback region. Accordingly, the system controller 130 controls the positioning of the rotation θ_{z}, by using the servo signal calculated by the formula (5). When the reproduction signal SA is smaller than the predetermined threshold value, the system controller 130 determines that the region is the positive feedback region, and does not control the positioning of the rotation θ_{z}. In this manner, it is possible to control the positioning of the rotation θ_{z}, whose robust stability is improved.

The predetermined threshold value may be any value, as long as the value can prevent the positioning control of the rotation θ_{z} from being performed in the positive feedback region.

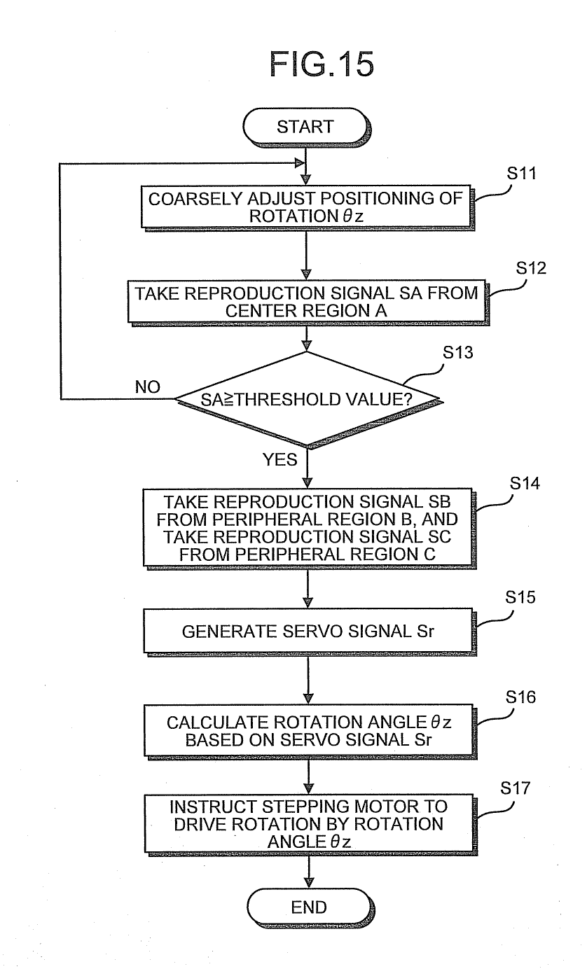

A processing procedure of the positioning control of the rotation θ_{z} of the holographic memory recording medium 111 according to the present embodiment will now be described with reference to FIG. 15.

The system controller 130 sends a driving instruction to the stepping motor 123, rotates the holographic memory recording medium 111 by θ_{z}, and coarsely adjusts the positioning (Step S11).

The system controller 130 then takes a reproduction signal SA of the center region A from the reproduction signals generated by the reproduction light received by the two-dimensional image pickup device 117 (Step S12), and determines whether the reproduction signal SA is equal to or more than a predetermined threshold value (Step S13). If the reproduction signal SA is smaller than the predetermined threshold value (NO at Step S13), the system controller 130 determines that the reproduction signal is still in a range of the positive feedback region and coarsely adjusts the positioning by returning to Step S11. Accordingly, the system controller 130 does not perform the positioning control of the rotation θ_{z}, using the servo signal Sr.

At Step S13, if the reproduction signal SA is equal to or more than the predetermined threshold value (YES at Step S13), the system controller 130 performs the positioning control of the rotation θ_{z}, using the servo signal Sr as follows:

In other words, the system controller 130 takes a reproduction signal SB of the peripheral region B and a reproduction signal SC of the peripheral region C from the reproduction signals generated by the reproduction light received by the two-dimensional image pickup device 117 (Step S14). The differentiator 1101 of the system controller 130 then generates a servo signal Sr by performing a differential operation on both of the reproduction signals using the formula (5) (Step S15).

The system controller 130, based on the generated servo signal Sr, calculates the rotation angle θ_{z} of the holographic memory recording medium 111 (Step S16). The system controller 130 then sends a rotation driving instruction to the stepping motor 123, so as to rotate the holographic memory recording medium 111 only by the calculated rotation angle θ_{z} (Step S17). Accordingly, the stepping motor 123 rotates the holographic memory recording medium 111 only by the specified rotation angle θ_{z}. As a result, the positioning control of the rotation angle θ_{z} of the holographic memory recording medium 111 is performed.

In this manner, in the holographic memory recording/reproducing apparatus according to the first embodiment, among the reproduction signals received by the two-dimensional image pickup device 117, a differential operation is performed on the reproduction signals of the peripheral regions B and C, that are two regions divided by the line segment where the plane of incidence of the reference light 115 intersects with the reproduction image (a plane of the holographic memory recording medium 111), thereby generating a servo signal. The positioning control of the rotation θ_{z} of the holographic memory recording medium 111 is performed by using the servo signal. Accordingly, it is possible to perform the precise positioning control of the rotation θ_{z}. As a result, it is possible to realize the highly accurate recording and reproduction of information.

A second embodiment will now be described. In the holographic memory recording/reproducing apparatus according to the first embodiment, the DMD is used as a spatial light modulator. However, in the holographic memory recording/reproducing apparatus according to the second embodiment, a ferroelectric liquid crystal device is used as the spatial light modulator.

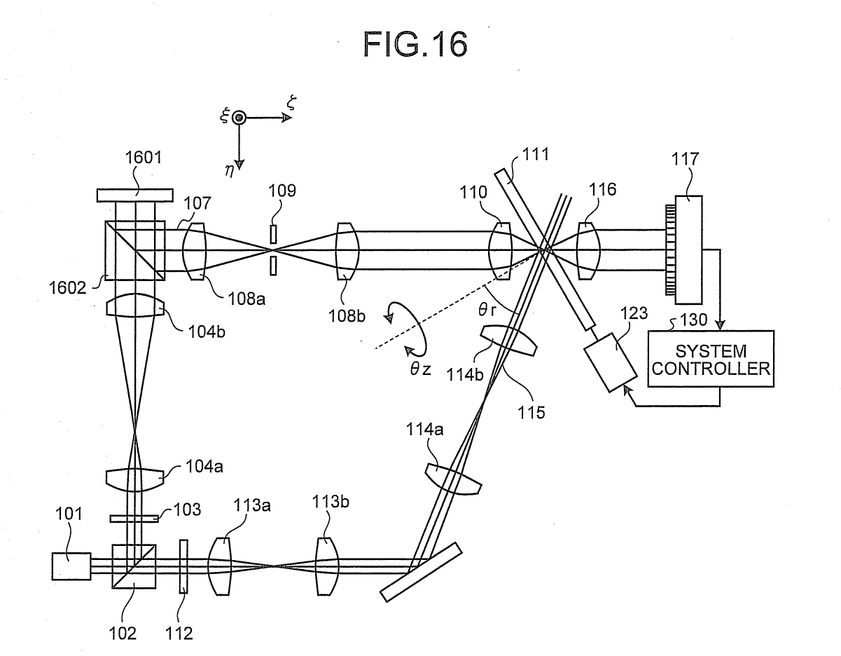

In the present embodiment, as shown in FIG. 16, a ferroelectric liquid crystal device 1601 is disposed as the spatial light modulator. The ferroelectric liquid crystal device 1601 is an intensity modulator that has a high response speed of tens of microseconds, and suitable for a hologram recording/reproducing system.

Because the ferroelectric liquid crystal device 1601 is used in the present embodiment, unlike the arrangement of the DMD in the first embodiment, there is no need to incline the ferroelectric liquid crystal device 1601 at 45 degrees. Accordingly, laser light from the semiconductor laser device 101 transmits though a beam splitter 1602, led into the ferroelectric liquid crystal device 1601, and converted into information light by having the optical intensity modulated. The light is again emitted to the beam splitter 1602, reflected by the beam splitter 1602, and collected on the holographic memory recording medium 111. Other optical configurations are the same as those in the first embodiment.

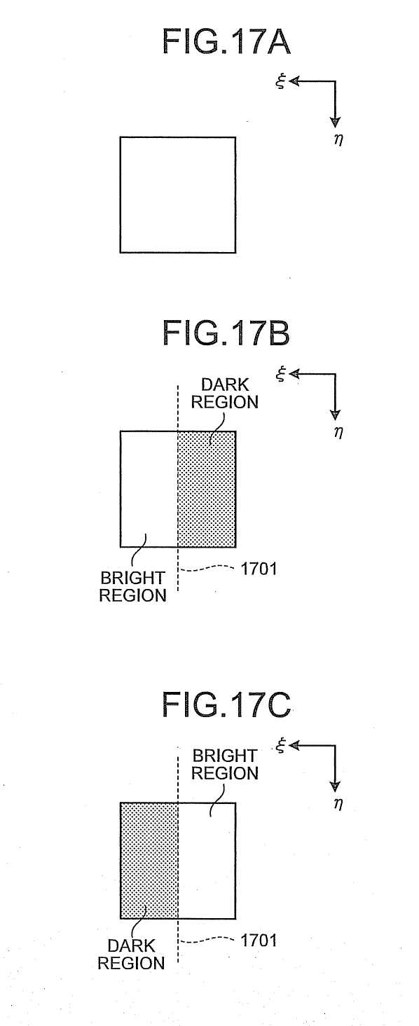

FIGS. 17A to 17c are schematic views of the intensity distribution of reproduction signals, when the holographic memory recording medium 111 is rotated by θ_{z} only at a fine angle from the optimum reproducing position. In FIGS. 17A to 17C, a ξη-axis corresponds to the ξη-axis shown in FIG. 16.

FIG. 17A is a schematic view of the intensity distribution of reproduction signals at the optimum reproducing position. More precisely, the reproduction image is a two-dimensional pattern formed by a number of bright spots and dark spots. For explanation purposes, the whole of FIG. 17A is illustrated by bright spots. FIG. 17B is a schematic view of the intensity distribution of reproduction signals, when the holographic memory recording medium 111 is rotated by θ_{z} only at a fine angle −δ deg from the optimum reproducing position (FIG. 17A). FIG. 17C is a schematic view of the intensity distribution of reproduction signals, when the holographic memory recording medium 111 is rotated by θ_{z} only at a fine angle +δ deg from the optimum reproducing position (FIG. 17A).

A dotted line 1701 in FIGS. 17B and 17C is a line segment where the plane of incidence of the reference light 115 intersects with the reproduction image (a plane of the holographic memory recording medium 111). When the holographic memory recording medium 111 is rotated by θ_{z} only at a fine angle, similar to the first embodiment, as shown in FIGS. 17B and 17C, the two regions at the left and right separated by the line segment 1701 are divided into a bright region and a dark region, thereby generating intensity fluctuations. If the rotating direction of θ_{z} at a fine angle is reversed, the characteristic of the intensity fluctuations is also reversed.

Accordingly, also in the present embodiment, a servo signal is generated by performing a differential operation on the reproduction signals in the two regions using the formula (5), and the servo signal is used to control the positioning of the rotation θ_{z}. The processing of the positioning control of the rotation θ_{z} is performed similar to that in the first embodiment.

In this manner, in the holographic memory recording/reproducing apparatus according to the second embodiment, similar to the first embodiment, it is possible to perform the precise positioning control of the rotation θ_{z}. Accordingly, it is possible to realize the highly accurate recording and reproduction of information. In the holographic memory recording/reproducing apparatus according to the second embodiment, the ferroelectric liquid crystal device 1601 is used as a spatial light modulator. Subsequently, it is possible to dispose the ferroelectric liquid crystal device 1601 without inclining, thereby improving the flexibility of optical configuration.

A third embodiment will now be described. A holographic memory recording/reproducing apparatus according to the third embodiment divides the reproduction light into servo reproduction light and information reproduction light, and uses a photodetector whose light-receiving surface is divided into two, as a light-receiving unit that receives the servo reproduction light.

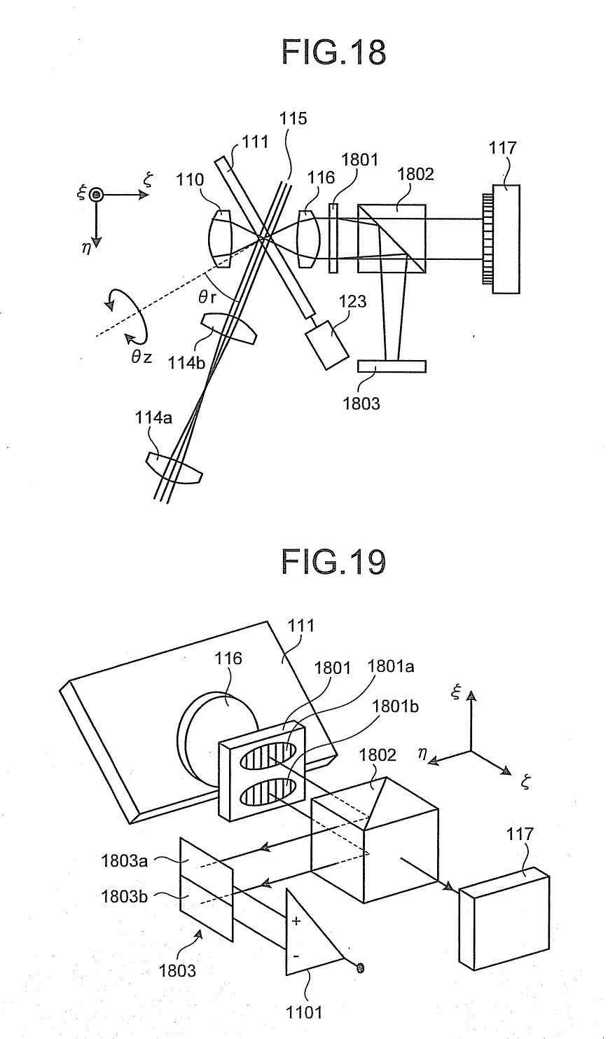

As shown in FIG. 18, in the present embodiment, an optical configuration of the optical path of the laser light output from the semiconductor laser device 101, converted into the information light 107 and the reference light 115, and emitted onto the holographic memory recording medium 111, is the same as that in the first and the second embodiments.

As shown in FIGS. 18 and 19, in the third embodiment, in between the holographic memory recording medium 111 and the two-dimensional image pickup device 117, the objective lens 116, a diffractive optical element (DOE) 1801, and a beam splitter 1802, are sequentially disposed from the recording medium side. The objective lens 116 converts reproduction light output from the holographic memory recording medium 111 to parallel light beams. The DOE 1801 diffracts and divides the reproduction light. The beam splitter 1802 further divides the reproduction light.

Gratings 1801a and 1801b are formed on the DOE 1801. The gratings 1801a and 1801b diffract the reproduction light divided at the plane of incidence (ηζ plane) of the reference light 115, respectively into ξ>0 and ξ<0. The gratings 1801a and 1801b are formed at positions where the rays of reproduction light from two regions transmit through the DOE 1801. The two regions are produced by dividing the reproduction image by the line segment where the plane of incidence of the reference light 115 intersects with the reproduction image. Accordingly, the gratings 1801a and 1801b divide the reproduction light output from the holographic memory recording medium 111 into rays of reproduction light output from the two regions divided by the line segment where the plane of incidence of the reference light 115 intersects with the reproduction image. The rays of reproduction light are diffracted by the gratings 1801a and 1801b, and converted into condensed light beams. The condensed light beams are reflected by the beam splitter 1802 that divides the light beams at a predetermined light quantity ratio, and are collected on a photodetector 1803 as servo reproduction light.

Among the rays of reproduction light output from the holographic memory recording medium 111, the rays of reproduction light that have passed through the regions other than the gratings 1801a and 1801b, transmit though the beam splitter 1802 as the parallel light beam without being changed, and received by the two-dimensional image pickup device 117 as information reproduction light.

The photodetector 1803 is provided to improve the speed of controlling the positioning of the rotation θ_{z}, and the light-receiving surface is divided into two. In other words, the light-receiving surface is formed by a light-receiving surface 1803a that receives the servo reproduction light from the grating 1801a, and a light-receiving surface 1803b that receives the information reproduction light from the grating 1801b. The differentiator 1101 performs a differential operation on the reproduction signals generated by the servo reproduction light from the light-receiving surfaces, thereby generating a servo signal. The servo signal is then used to control the positioning of the rotation θ_{z} of the holographic memory recording medium 111. The processing of the positioning control of the rotation θ_{z} is performed similar to that in the first embodiment.

In the holographic memory recording/reproducing apparatus according to the third embodiment, similar to the first embodiment, it is possible to perform the precise positioning control of the rotation θ_{z}. Accordingly, it is possible to realize the highly accurate recording and reproduction of information. In the holographic memory recording/reproducing apparatus according to the third embodiment, the reproduction light is divided into the servo reproduction light and the information reproduction light, and the photodetector in which the light-receiving surface is divided into two is used as a light-receiving unit of the servo reproduction light. Accordingly, it is possible to improve the speed of the positioning control of the rotation θ_{z}.

A fourth embodiment will now be described. In the holographic memory recording/reproducing apparatus in the first to the third embodiments, the reproduction light for generating a servo signal and the information reproduction light are obtained from illumination light output from a single semiconductor laser device. However, the holographic memory recording/reproducing apparatus according to the fourth embodiment includes two light sources of a semiconductor laser device for servo and a semiconductor laser device for recording and reproducing. A servo signal is generated by the reproduction light of the laser light output from the semiconductor laser device for servo, and the processing of the positioning control of the rotation θ_{z} is performed using the servo signal.

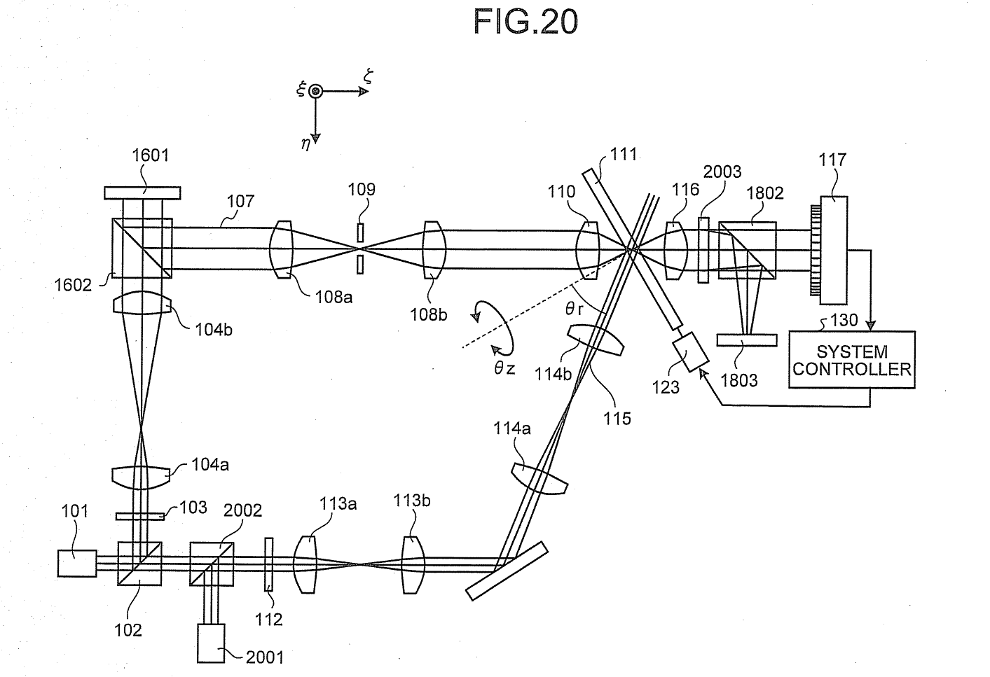

In the present embodiment, as shown in FIG. 20, the semiconductor laser device 101 that emits recording/reproducing laser light, and a semiconductor laser device 2001 that emits servo laser light are provided.

The semiconductor laser device 101, similar to the first to the third embodiments, emits blue-violet laser light with a wavelength of a 405 nanometer band as recording/reproducing laser light. The semiconductor laser device 2001 emits red semiconductor laser light with a wavelength of a 650 nanometer band, whose wavelength is different from the recording/reproducing laser light, as servo laser light.

As shown in FIG. 20, the servo laser light output from the semiconductor laser device 2001 is combined with the optical path of the reference light in a dichroic prism 2002, and led into the holographic memory recording medium 111 in which data is recorded. The optical configuration of the optical path of the recording/reproducing laser light output from the semiconductor laser device 101, converted into the information light 107 and the reference light 115, and emitted onto the holographic memory recording medium 111, is the same as that in the second embodiment.

The reproduction light output from the holographic memory recording medium 111 includes information reproduction light after the blue-violet recording/reproducing laser light is emitted onto the holographic memory recording medium 111 as reference light, and servo reproduction light after the servo red laser light is emitted onto the holographic memory recording medium 111.

In between the holographic memory recording medium 111 and the two-dimensional image pickup device 117, the objective lens 116, a diffractive optical element (DOE) 2003 for red color, and the beam splitter 1802 are sequentially arranged from the recording medium side. The function of the beam splitter 1802 is the same as that of the third embodiment.

The reproduction light output from the holographic memory recording medium 111, in other words, the information reproduction light and the servo reproduction light, is converted into parallel light beams by the objective lens 116, and led into the DOE 2003 for red color. The DOE 2003 for red color is an element designed to diffract the red laser light with a wavelength of a 650 nanometer band, without diffracting the blue-violet laser light with a wavelength of a 405 nanometer band. Accordingly, among the rays of reproduction light output from the holographic memory recording medium 111, the information reproduction light is the blue-violet laser light with a wavelength of a 405 nanometer band. Subsequently, the information reproduction light is not diffracted by the DOE 2003 for red color, thereby being led into the beam splitter 1802 as parallel light beams without being changed. Similar to the third embodiment, the information reproduction light transmits through the beam splitter 1802 and received by the two-dimensional image pickup device 117.

Among the rays of reproduction light output from the holographic memory recording medium 111, the servo reproduction light is the red laser light with a wavelength of a 650 nanometer band, thereby being diffracted by the DOE 2003 for red color and converted into condensed light beams. The light is then reflected by the beam splitter 1802, and collected into the photodetector 1803. Similar to the third embodiment, the light-receiving surface of the photodetector 1803 is divided into two. Accordingly, similar to the third embodiment, the differentiator 1101 performs a differential operation on the reproducing signals generated by the servo reproduction light from the light-receiving surfaces of the photodetector 1803, thereby generating a servo signal. The servo signal is then used for controlling the positioning of the rotation θ_{z} of the holographic memory recording medium 111. The processing of the positioning control of the rotation θ_{z} is performed similar to that in the first embodiment.

In this manner, in the holographic memory recording/reproducing apparatus according to the fourth embodiment, similar to the first embodiment, it is possible to perform the precise positioning control of the rotation θ_{z}. As a result, it is possible to realize the highly accurate recording and reproduction of information. In the holographic memory recording/reproducing apparatus according to the fourth embodiment, laser light having the different wavelength from that of the recording/reproducing laser light, is used as the servo reproduction light. Accordingly, it is possible to improve the light usage efficiency of the recording/reproducing laser light. In the holographic memory recording/reproducing apparatus according to the fourth embodiment, it is possible to design the sensitivity of the holographic memory recording medium 111 to practically zero, by the wavelength of the servo laser light. In other words, it is possible to design the holographic memory recording medium 111 so as not to be exposed by the laser light with a wavelength of a 650 nanometer band. Accordingly, it is possible to prevent the deterioration of the holographic memory recording medium 111, caused by the illumination of the servo laser light.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information reproducing apparatus comprising:
a light-receiving unit that receives a first reproduction light of an information output from a first region of an information recording layer and a second reproduction light of an information output from a second region of the information recording layer, the first region and the second region being formed by dividing the information recording layer with a line segment that intersects a plane of incidence of the reference light and a plane of the information recording layer, and outputs a first reproduction signal that is a reproduction signal of the first region and a second reproduction signal that is a reproduction signal of the second region;
a driving unit that rotates the optical information recording medium in a thickness direction of the optical information recording medium and in a surface direction of the optical information recording medium;
a differentiator that generates a servo signal by performing a differential operation on the first reproduction signal and on the second reproduction signal; and
a record controlling unit that controls the light source to emit the illumination light, and performs angular multiplex recording of the information on the information recording layer, controlling rotation by the driving unit, adjusting a rotation angle in the thickness direction based on the servo signal.

2. The apparatus according to claim 1, further comprising:
a dividing unit that divides the first reproduction light and the second reproduction light into an information reproduction light and a servo reproduction light for generating a servo signal; wherein
the light-receiving unit includes an information-reproduction-light receiving unit and a servo-light receiving unit, and
the differentiator generates a servo signal by performing the differential operation on the first reproduction signal and the second reproduction signal.

3. The apparatus according to claim 2, further comprising a diffraction element that diffracts a first servo reproduction light from the first region and a second servo reproduction light from the second region, and collects the first servo reproduction light and the second servo reproduction light onto the servo-light receiving unit.

4. The apparatus according to claim 2, wherein the servo-light receiving unit is a photodetector.

5. The apparatus according to claim 1, further comprises
a diffraction element that diffracts only the first servo reproduction light and the second servo reproduction light and collects the first servo reproduction light and the second servo reproduction light on the servo-light receiving unit.

6. An optical information reproducing method comprising:
receiving a first reproduction light of an information output from a first region of an information recording layer and a first reproduction light of an information output from a second region of the information recording layer, the first region and the second region being formed by dividing the information recording layer with a line segment that intersects a plane of incidence of the reference light and a plane of the information recording layer, and outputting a first reproduction signal that is a reproduction signal of the first region and a second reproduction signal that is a reproduction signal of the second region;
rotating the optical information recording medium by a driving unit in a thickness direction of the optical information recording medium and in a surface direction of the optical information recording medium;
generating a servo signal by performing a differential operation on the first reproduction signal and on the second reproduction signal; and
controlling the light source to emit the illumination light, and performing angular multiplex recording of the information on the information recording layer, controlling rotation by the driving unit, adjusting a rotation angle in the thickness direction based on the servo signal.
